(19) United States
(12) Patent Application Publication
(10) Pub. No.: US 2007/0011472 A1
(43) Pub. Date: Jan. 11, 2007

(54) Secure power-saving harddisk storage system and method

(75) Inventor: Yu-Ju Cheng, Hsi-Chih City (TW)

Correspondence Address: HDSL, 4331 STEVENS BATTLE LANE, FAIRFAX, VA, 22033, US

(73) Assignees: JU-SOFT CO., LTD; CENTOS INC.

(21) Appl. No.: 11/172,808

(22) Filed: Jul. 5, 2005

(51) Int. Cl. G06F 1/00

(52) U.S. Cl. 713/300

(57) ABSTRACT

A secure power-saving hard disk storage system and method having a plurality of storage units and a control unit connected to an external controller. The system detects and checks information of installation of each storage unit and control unit, driving program and format stored at the control end while executing installation. During storage selection, the storage unit selected to execute data access is conducted with a power source via an electronic switch of the control unit to activate data transmission connection. The activated storage unit then executes data access according to store or read command input from the control end. When the storage unit is no longer in use, the power source is switched to improve synchronous conduction, power consumption, high noise and greenhouse effect of high temperature generated thereby.

### BACKGROUND OF THE INVENTION

1. Field of Invention

The present invention relates in general to secure power-saving hard disk storage system and method, and more particularly, to data storage system and method applied to data storage of mass but rarely-access data. Only when access of such data is required, an assigned storage is conducted to a power source via a control unit at a control end. When the data access is not required, the power source is switched off. Thereby, the objectives of power saving, low noise and low heat generation can be achieved by a simply and economic structure.

2. Related Art

It is known that large yet seldom accessed data, e.g. video recordings of security or surveillance cameras, are usually recorded and stored on videotapes. However, such video recording devices and tapes are expensive and do not provide enough storage space. Moreover, such tapes need to be frequently replaced, and it is very time-consuming trying to locate a specific clip on a tape.

Currently, the traditional video recording devices and tapes are increasingly being replaced by cheaper computer systems and high-volume storage peripherals for data storage. However, these multi-storage units in the computer systems are always running even when not being accessed (read or written on), resulting in energy waste, excessive noises and heat, which is a major contributor to the green house effect. Powerful heat sinks installed to address the thermal problem, on the other hand, increase the cost and power consumption of the conductor configuration. Furthermore, the constant running of storage devices could wear out the axis and shorten the life of such storage devices.

### SUMMARY OF THE INVENTION

By the design of a control program at a control end and the connection between a control unit and a plurality of storages via a plurality of switches, a selected storage unit is conducted or activated only when data access of the storage unit is required. When the data access is not required, the power source of the storage unit is switched off. Thereby, the storage units do not have to be always conducted to greatly reduce the power consumption. In addition, as the storage units are not always conducted, the noise and heat generated thereby are greatly reduced too.

### BRIEF DESCRIPTION OF THE DRAWINGS

The present invention will become more fully understood from the detailed description given hereinbelow illustration only, and thus are not limitative of the present invention, and wherein:

FIG. 1 is a schematic drawing of the system framework in an embodiment of the present invention;

FIG. 2 is a schematic drawing of the control unit in an embodiment of the present invention;

FIG. 3 is a schematic drawing of the storage unit in an embodiment of the present invention; and

FIG. 4 is a flow chart of the software control in an embodiment of the present invention.

### DETAILED DESCRIPTION OF THE INVENTION

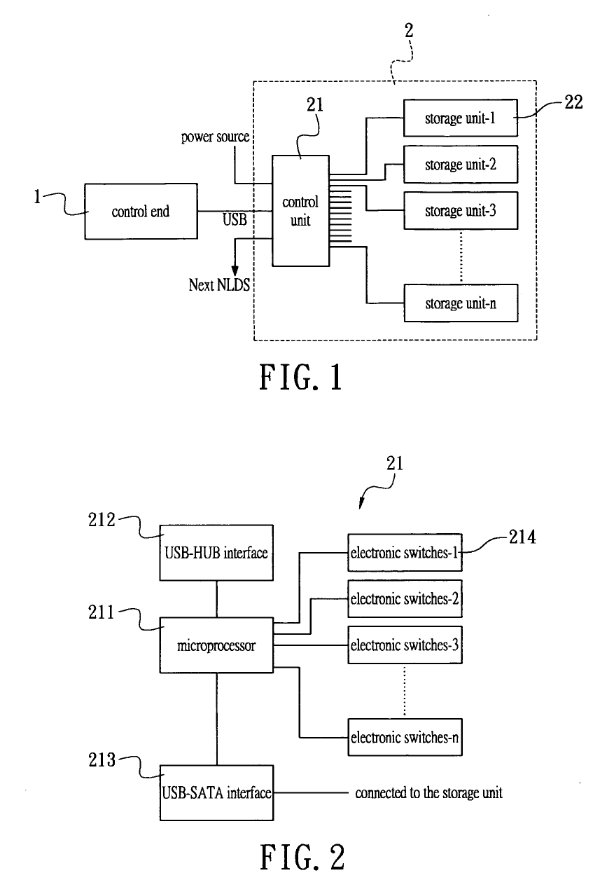

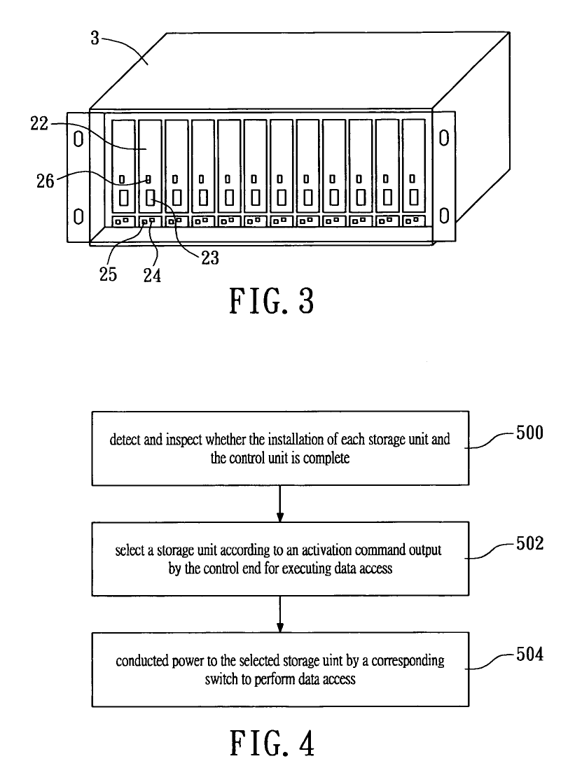

Referring to FIGS. 1, 2 and 3, the power-saving hard disk storage system includes a control end and a near-line disk storage (NLDS) system 2 connected to the control end 1. The connection between the NLDS storage system 2 and the control end 1 is between online and offline status to construct a power-saving, low-noise and low-heat storage control system. Such system is applicable to access of mass but rare-access data content, such as the data captured by domestic or military surveillance system, conference record, and image captured by television stations.

The control end 1 includes an application computer device to establish control signal connection via a connection interface such as a USB2 interface and the NLDS system 2. The same USB2 interface can be used to simulate RS232 for transmission of the control signal.

The NLDS system 2 includes a control unit 21 configured with the multiple electronic switches 214 each controlling the connection between the corresponding storage unit 22 and a power source.

The control unit 21 is further comprised of a microprocessor 211, a USB-HUB interface 212 connected to the microprocessor 211 to provide signal connection between the adjacent NLDS system 2 and control end 1, a USB-SATA interface 213 for executing conversion and output of USB and SATA and connection to the storage units 22, and a circuit board (not illustrated) which provides slots for the installation of the microprocessor 211, USB-HUB interface 212, USB-SATA interface 213 and electronic switches 214.

The storage units 22 are installed in the system case 3 and can be stacked up and expanded. Each storage unit 22 has its independent power socket 23, power indicator 24, access indicator 25, and connection port 26. Preferably, the connection port 26 includes a SATA interface connection port.

Since the storage units 22 are individually connected to the corresponding electronic switches 214 of the control unit 2, each storage unit 22 can be activated and conducted to a power source according to a software program command by one electronic switch 214 of the control end. The activated storage unit 22 is then operative to perform data access. When the data access is complete or not required any more, the conduction between the storage unit 22 and the power source is cut off. Therefore, the power consumption is greatly reduced. The unused or unselected storage units will not be conducted to avoid wearing caused by continuous operation. Therefore, the lifetime can be lengthened.

The secure power-saving disk storage method illustrated in FIG. 4 includes the follow steps. The control end 1, the control unit 21 and the storage units 22 are installed and connected. An installation step 500 is performed to detect and inspect whether the installation of each storage unit 22 and the control unit 21 is complete. The step includes detection and inspection of location, brand, capacity and power source of the connection interface, conduction test of data lines, driving program and the format procedure, including executing format of the unformatted storage unit 22 first. The above installation information is saved in the control end 1. Meanwhile, the conduction operation is also inspected. In step 502, a storage unit 22 is selected according to an activation command output by the control end for executing data access. Upon activation, in step 504, the selected storage unit 22 is controlled by the corresponding switch 214 to be conducted to a power source. Thereby, the selected storage unit 22 is operative to perform data access.

When the storage unit 22 is full during execution of data access in the above step 504, the control unit 1 cut off the connection between the storage unit 22 and the power source, and activates anther storage unit 22 to continue data access.

As the storage units 22 which are not working are disconnected, the power is saved, and the data saved therein is prevented from being stolen or damaged.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A secure power-saving disk storage system comprising:
a control unit;
a plurality of electronic switches installed in the control unit; and
a plurality of storage units each being controlled by one corresponding electronic switch for connecting to a power source.

2. The system of claim 1 wherein the control unit is connected to an external controller, wherein the controller includes a computer system.

3. The system of claim 1 wherein the said control unit comprising:
a microprocessor;
at least one USB-HUB interface connected to the microprocessor for connecting adjacent disk storage systems and signals at the control end
a USB-SATA conversion interface for converting and outputting of signals between USB and SATA to a selected one of the storage units; and
a circuit board which provides slots for installing the microprocessor, the USB-HUB interface, the USB-SATA interface and the electronic switches threreon.

4. The system of claim 1 wherein each storage unit includes an independent power socket, an independent power indicator, an independent access indicator, and an independent connection port.

5. The system of claim 4 wherein the connection port includes a SATA interface connection port.

6. A secure power-saving disk storage system comprising:
a control end;
a control unit;
a plurality of electronic switches installed in the control unit; and
a plurality of storage units connected to the electronic switches, wherein the electronic switches control power conduction of the corresponding of storage units.

7. A method of a secure power-saving disk storage system wherein:
selecting one of a plurality of storage units for executing data access;
using an electronic switch to conduct the selected storage unit to a power source; and
performing data access by the selected storage unit.

8. The method of claim 7 further comprising a step of detecting and inspecting installation of the storage unit and a control unit selecting and controlling power conduction of the storage unit, a driving program and format information of the storage unit.

9. The method of claim 7 further comprising a step of saving information saved at the storage unit in a control end, and inspecting whether a storage system comprising the storage units is operating normally.

10. The method of claim 7 further comprising disconnecting the storage units that are not selected from the power source.
